(19) United States
(12) Patent Application Publication
(10) Pub. No.: US 2019/0182701 A1
(43) Pub. Date: Jun. 13, 2019

(54) CLIENT CENTRIC SERVICE QUALITY CONTROL

(71) Applicant: VID SCALE, INC., Wilmington, DE (US)

(72) Inventors: Byung K. YI, San Diego, CA (US); Yan YE, San Diego, CA (US); Yong HE, San Diego, CA (US); Eduardo ASBUN, Santa Clara, CA (US); Srinivas GUDUMASU, San Diego, CA (US); Ahmed HAMZA, Montreal (CA)

(73) Assignee: VID SCALE, Inc., Wilmington, DE (US)

(21) Appl. No.: 16/302,840

(22) PCT Filed: May 19, 2017
(86) PCT No.: PCT/US2017/033494

§ 371 Date: Nov. 19, 2018

Related U.S. Application Data
(60) Provisional application No. 62/338,906, filed on May 19, 2016.

(51) Int. Cl. H04W 28/02; H04L 12/14; H04L 12/24; H04L 12/851; H04L 29/08; H04L 12/801

(52) U.S. Cl. CPC H04W 28/0215; H04L 12/1435; H04L 12/1489; H04L 47/39; H04L 47/2425; H04L 67/306; H04L 41/5025

(57) ABSTRACT

Systems, methods, and instrumentalities are disclosed for managing a service quality for data consumption with a wireless transmit/receive unit (WTRU), comprising determining a cost associated with obtaining the data, determining an amount of unused data in a monthly data plan, determining a preference for a content type related to the data: determining an amount of congestion in a network over which the data will be received, determining a desired service quality value based upon the cost, unused data, preference, and network congestion, comparing the desired service quality value to a set of representations of the data, wherein each of the representations is associated with a different service quality (for example, each of the representations may have an associated bitrate, and wherein each bitrate may be associated with a different service quality), and requesting the data at a representation having a quality closest to the desired service quality value.

### CROSS REFERENCE TO RELATED APPLICATION

This application claims priority to U.S. provisional patent application No. 62/338,906, filed May 19, 2016, which is incorporated herein by reference in its entirety.

### BACKGROUND

Technological innovation has been realized at all stages of the video delivery chain, such as video compression technologies, network delivery technologies, and network infrastructure evolution. Forms of non-linear, multi-device internet-based video streaming services have grown over the past decade. According to Nielsen's fourth-quarter 2014 Total Audience Report, 40 percent of U.S. homes have subscribed to a streaming service such as Netflix, Amazon Instant Video or Hulu, compared with 36 percent in the fourth quarter of 2013.

The landscape of connected devices has shifted during the past decade, for instance, in 2005, 93% of all connected devices were computers and 6% were mobile devices. By 2013, 38% of all connected devices were computers and 52% were mobile devices. Estimates show that by 2018, 20% of all connected devices will be computers and 66% will be mobile devices. With expanded use of mobile devices, it may be beneficial to develop ways to improve user experience.

### SUMMARY

Systems, methods, and instrumentalities are disclosed for managing a service quality for data consumption with a wireless transmit/receive unit (WTRU), comprising determining a cost associated with obtaining the data, determining an amount of unused data in a monthly data plan, determining a preference for a content type related to the data; determining an amount of congestion in a network over which the data will be received, determining a desired service quality value based upon the cost, unused data, preference, and network congestion, comparing the desired service quality value to a set of representations of the data, wherein each of the representations is associated with a different service quality (for example, each of the representations may have an associated bitrate, and wherein each bitrate may be associated with a different service quality), and requesting the data at a representation having a quality closest to the desired service quality value.

### BRIEF DESCRIPTION OF THE DRAWINGS

FIG. 1 depicts an example content delivery network (CDN) cache.

FIG. 2 depicts an example of adaptive streaming.

FIG. 3 depicts an example non-flat data rate update.

FIG. 4 depicts an example client centric service quality scheduler.

FIG. 5 depicts an example client centric service quality control based adaptive streaming.

FIG. 6 depicts an example user preference selection of a data reduction setting.

FIG. 7 depicts an example service quality controller implementation.

FIG. 8 depicts an example service quality scheduler for real-time video communications.

FIG. 9 depicts an example multi-party video conferencing.

FIG. 10 depicts an example of a service quality setting changing based on time.

FIG. 11 depicts an example of a service quality setting changing based on location.

FIG. 12 depicts an example network carrier data package selection.

FIG. 13 depicts an example mapping of quality of service (QoS) metrics to network performance metrics (NPMs).

FIG. 14A is a system diagram of an example communications system in which one or more disclosed embodiments may be implemented.

FIG. 14B is a system diagram of an example wireless transmit/receive unit (WTRU) that may be used within the communications system illustrated in FIG. 14A.

FIG. 14C is a system diagram of an example radio access network and an example core network that may be used within the communications system illustrated in FIG. 14A.

FIG. 14D is a system diagram of another example radio access network and an example core network that may be used within the communications system illustrated in FIG. 14A.

FIG. 14E is a system diagram of another example radio access network and an example core network that may be used within the communications system illustrated in FIG. 14A.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

According to a 2015 Cisco annual internet traffic forecast, global mobile data traffic reached 2.5 Exabyte per month at the end of 2014, up from 1.5 Exabyte per month at the end of 2013. Mobile video traffic exceeded fifty percent of total mobile data traffic by the end of 2012 and grew to fifty-five percent by the end of 2014. Forecasts estimate that nearly three quarters of the world's mobile data traffic will be video by 2019 and mobile video will increase thirteen-fold between 2014 and 2019. Mobile voice, data, and video services are quickly becoming an essential part of people's daily lives.

The evolution of network infrastructure and/or video compression technologies cannot meet the dramatic increase of data consumption (e.g., especially the video data consumption over mobile networks). A content delivery network (CDN) may be used to handle heavy video traffic over the entire network.

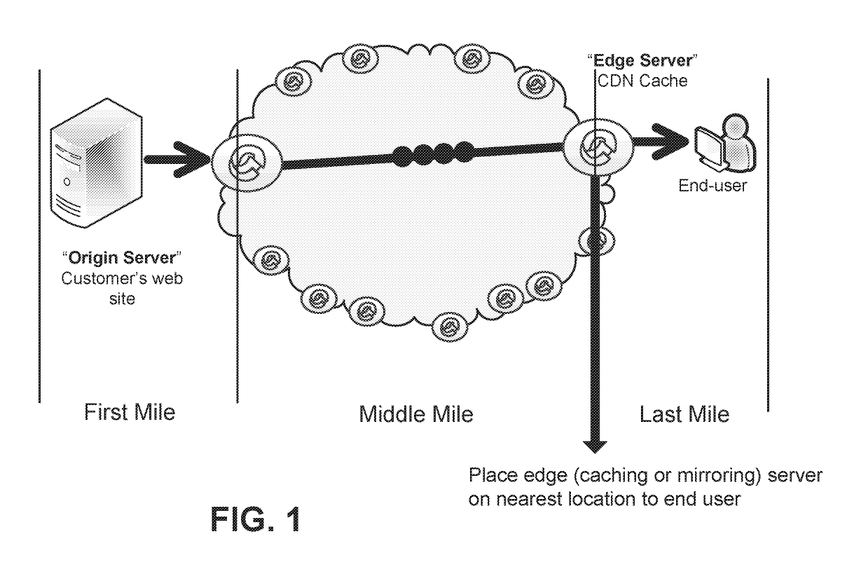

FIG. 1 depicts an example CDN cache. A CDN may deploy a large number of caching servers (e.g., worldwide). The CDN may use the large number of caching servers to push content to the edges of the Internet. One or more edge caches may store popular content and/or distribute the popular content to an end user, for example, upon request to offload traffic served from the origin server and/or reduce the service access latency for one or more end users. The CDN performance (e.g., such as access latency) may fluctuate among different providers and/or different locations. The cost of deploying CDNs may be substantial in order to accommodate a large volume of mobile video data. The return on investment associated with the infrastructure investment of deploying CDNs may be small due to lower margins. CDNs and/or edge servers may not reach the entire internet.

Content delivery systems may be converging towards using adaptive video streaming over HTTP (e.g., to accommodate the network fluctuation and/or provide adequate video quality to the end user). There may be multiple adaptive video formats such as MPEG-DASH, Apple HTTP live streaming (HLS), and/or Microsoft smooth streaming. The multiple adaptive video formats may use similar mechanisms.

In adaptive streaming, a number of presentations of the same content may be generated. Each of the number of presentations may be segmented into smaller chunks and/or segments. The segmented smaller chunks and/or segments may have varying lengths, for example, between 2 and 10 seconds. When a user (e.g., a client) requests a video content, the host server may send, back to the user, a description of the media presentation description (MPD) manifest file. The description of the MPD manifest file may include one or more (e.g., all) available bitrates of the requested content. The description of the MPD manifest file may include a potential URL to download the video content. A client may start requesting segments at a relatively low rate (e.g., to reduce initial session startup delay). Based on the time it takes to receive a requested segment, the client may determine (e.g., assess) the network conditions and/or request (e.g., choose) a next segment available according to the MPD based on one or more factors, including the client's quality requirements, network bandwidth, the determined network conditions, and/or device capabilities. The client may receive a better quality video with lower latency, shorter start-up time, and/or buffering time.

User-generated video content (e.g., video recording on smartphones) may be uploaded to a video sharing and/or social media sites such as YouTube, Vine, and/or Facebook at significant volume. The user-generated video contents may be viewed all over the world and/or may be shared privately or publicly. As mobile devices with the capability to record higher quality video become more prevalent, more and more high resolution videos may be uploaded to the video sharing and/or social media sites, increasing the network traffic and/or mobile data usage.

Real-time video applications such as face-to-face video chat and/or multi-party multi-stream video conferencing over wireless network may make use of high resolution, high frame rate, and/or high quality video (e.g., to improve user experience). The real-time video applications may increase the network traffic and/or mobile data usage.

Net neutrality requires the internet providers to treat all data on the internet equally, not discriminating or charging differentially by user, content, site, platform, applications, and mode of communication. Network service providers cannot control network traffic by treating the video traffic differently. An option to throttle the data speed for low profit margin users has been implemented by some network service operators (e.g., to reduce the network traffic and/or the operational cost). The FCC may fine network operators for throttling data speed for unlimited data plan users.

A user of a wireless transmit/receive unit (WTRU) may select a data plan based on one or more factors, including cost and/or data consumption habits. Different data plans may be offered by a network service operator. The different data plans may include a flat rate for an amount of gigabytes, a flat rate for unlimited data, or pre-paid for a limited amount of data. Some data plans (e.g., such as an international roaming data plan) may be more expensive, and the data cost may be more expensive when the user exceeds the data plan limit or allowance.

Social media sites (e.g., such as Facebook, WeChat, Vine, etc.) may stream video to a WTRU automatically when a user of the WTRU scrolls down to the content (e.g., without any playback button). A commercial provider may deliver various media information (e.g., attached to the apps) to a WTRU when the device connects to the network. Media content may consume a large amount of a user's data quota and the user may have limited ways to control the large data consumption.

Data consumption may be differentiated based on one or more of user preference, data cost, network traffic, and/or operational profit margin. The network operators cannot treat every bit differently and throttle the data speed accordingly. A streaming client implementing adaptive streaming protocols (e.g., such as DASH) may utilize the available network bandwidth (e.g., regardless of a user's preference and/or cost).

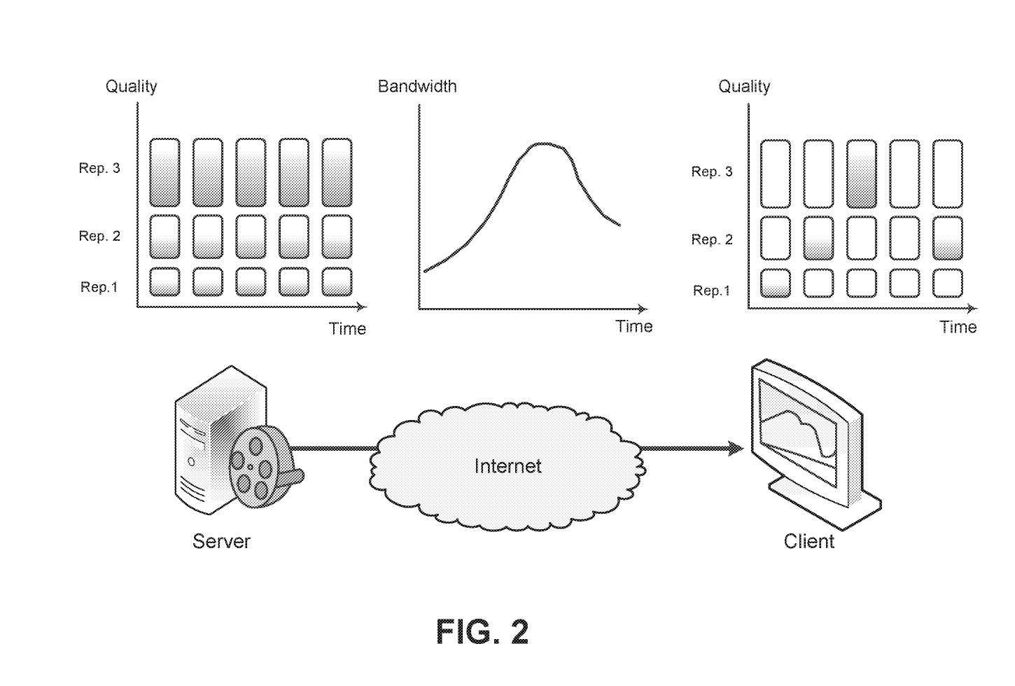

FIG. 2 depicts an example adaptive streaming. For example, a number of quality representations of the same video content may be stored on a server. A client (e.g., a WTRU) may request a quality representation of a video based on a bandwidth condition. When the bandwidth is low, the WTRU may request a low quality representation. When the bandwidth is high, the WTRU may request a high quality representation.

A user may have limited tools to schedule data consumption in advance and/or in real-time. The user may consume the same amount of data for the same content no matter how much each bit costs, and no matter how important the content is to the user. With limited tools to schedule data consumption, the user may not be able to select the quality of each bit dynamically, and the operators may not be able to sell better quality bits to the premium users paying more for the network access.

A client centric service quality control method may be provided to select a video bitrate and/or quality based on one or more factors. The term “service quality” refers to the user's overall experience accessing data on a mobile device, e.g., based upon one or more of cost, an amount of unused data, one or more favorite programs (e.g., preferences), and/or or a network congestion pattern, as well as, optionally, battery status. Service quality may include managing a data plan. Factors relevant to service quality may include user data consumption habits, a program schedule, and/or bandwidth cost. The client centric service quality control method may include benefits for both network operators and the end users.

A WTRU may include powerful sensing, storage, computing, control, and/or communications capabilities. The WTRU may manage a service quality configuration. The WTRU may determine a service quality to be received (e.g., to maximize the value proposition and the end user experience).

A client centric service quality control may be provided. A user of a receiving WTRU may select a media service. One or more factors may affect the user's selection of a service quality for the media service. The one or more factors may include the cost of each bit consumed, the location of the user (e.g., travelling internationally vs. staying in town), the user preference of the program, the amount of unused data left, and/or already scheduled service programs. The already scheduled service programs may affect a user with a monthly data plan allowance. For example, if the user (e.g., typically or historically) watches a certain weekly video program, the weekly video program may be considered as one or more already scheduled service programs for the remaining days in the month. The one or more already scheduled programs may be determined based on observing the user's watching behavior and/or based on examining a log of past programs watched by the user, for example.

The data expense, cost (E), may be associated with a data plan to which the user subscribes. The data plan may be a pre-paid data plan, an international roaming data plan, a limited domestic data plan and/or an unlimited domestic data plan. The cost (E) may be associated with a current location of the user, the network the user is connected to (e.g., free WiFi or paid wireless network), and/or a playback duration of the program. For example, the program may be classified as a short video program or a long form program.

For a flat-rate data plan, the cost of the data may depend on the amount of data to be requested, the total plan price, and/or the total amount of data provided by the plan. For example, the cost for requesting one chunk of data with size S may be estimated from the following Equation (1):

E=S*monthly_plan_charge/monthly_shared_data (1)

where monthly_plan_charge is the cost of the flat-rate data plan per month, and monthly_shared_data is the total amount of data allowed for the flat-rate data plan per month. As an example, a user may subscribe to a data plan which provides 4 Gbytes of data for a flat rate of $60 per month. In this case, Equation (1) may be applied to determine that usage of 100 Mbytes of data (e.g., in the course of watching streaming audio and/or video content) may effectively incur a cost of $1.50.

For a non-flat rate plan, the data expense may be updated (e.g., instantly updated) based on the time, location, and/or the access network provided to the client (e.g., 4G LTE 6-20 Mbps, 4G HSPA 4-12 Mbps, 3G HSPA 400-700 kbps, or 2G 40-200 kbps).

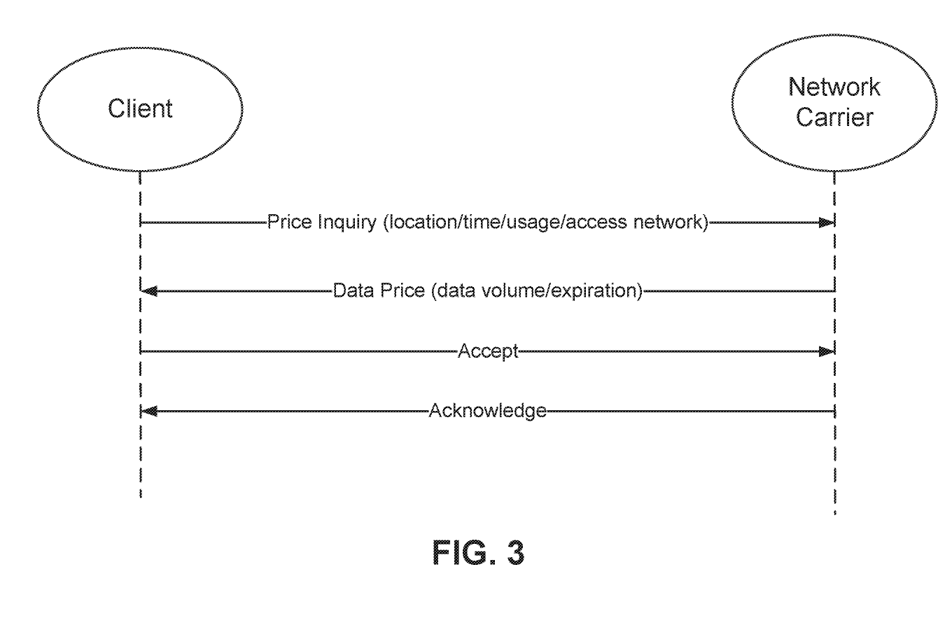

FIG. 3 depicts an example non-flat data rate update process flow. A client WTRU may send a price inquiry to a network carrier. The price inquiry may be in TCP/IP format or text message format. The price inquiry may include information such as location, time, amount of data usage requested, a preferred wireless network access bandwidth, and/or the like. The network carrier may respond to the client WTRU with relevant information such as the price and/or the expiration time. The client WTRU may send similar inquiries to more than one network carrier and may receive responses from more than one network carrier within a given time window. The client WTRU may select one of the offers that is considered the most suitable (e.g., based on cost and bandwidth considerations). The client WTRU may send an acknowledgement to the selected carrier. After the client WTRU selects the offer and/or sends the acknowledgement to the selected carrier, the negotiated data service may be enabled. The network carrier or operator may provide specific quality of service to the appropriate clients (e.g., users). For example, the client may specify one or more quality of service requirements and/or preferences when sending the price inquiry to the network carrier(s). The network carrier may provide information to the client about what quality of service will be provided when sending the response to the price inquiry. The client may benefit from the ability to choose from multiple offers.

An amount of unused data left (D) may be determined based on the subscribed data plan, the amount of data consumed, and/or the already scheduled service programs. The more data left, the more flexibility the user has when selecting the bit quality.

A user's program preference (P) may be may be determined based on gender, age, career, religion, and/or culture background, etc. The user's program preference (P) may indicate, rate, and/or rank specific programs and/or types/categories of programs which the user may prefer. One or more categories of programs (e.g., such as News, Sports, a particular TV show, new released movies, and/or the like) that a user is interested in may be predicted from the user's personal profile and/or from user viewing habit analysis. The user viewing habit analysis may include collecting the viewing data from the user viewing history. For example, a high P score may be assigned to a regular weekly video program that a user always watches. A low P score may be assigned to an embedded video commercial on a web page. A user interface may be provided to enable the user to set a different P score (e.g., manually) for different types of video (e.g., specific programs and/or categories of programs) they usually consume.

A network congestion pattern (C) may reflect the network's congestion level throughout the day. For example, the network congestion pattern (C) may indicate a period (e.g., such as particular hours of the day and/or particular days of the week) when more data traffic may occur in the network (for example, evening hours on Fridays and Saturdays when many people watch Netflix's video programs). The network congestion pattern (C) may reflect one or more specific locations at which a peak network load may be likely to occur (for example, a sports center when a large sports event is happening). A network operator may schedule a network load balancing in advance based on data consumption patterns of users in the area (e.g., to improve the network performance during the peak network load).

Indications of a user's favorite programs (P) and/or the network congestion pattern (C) may be determined based on a data analysis from the user's profile, the data consumption habits collected from user's daily activities, and/or the network traffic statistics. The user may configure the user favorite programs (P) manually based on his or her own experience, or from the network operator guidance. For example, each program may be assigned a P score. A high P score (e.g., above a predetermined threshold) may indicate that the program is one of the user's favorite programs. One or more categories may be defined based on one or more predetermined P score thresholds.

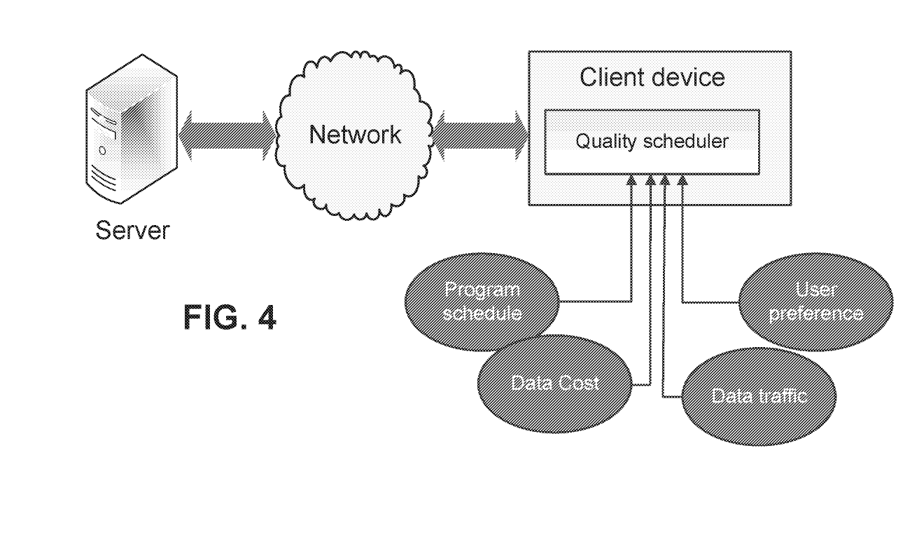

FIG. 4 depicts an example client centric quality scheduler. A client based quality scheduler may be used to determine the quality of service to be consumed by a receiving WTRU. The client based quality scheduler may be an app or a proxy installed on either the receiving WTRU side (e.g., as depicted in FIG. 4) or the network cloud linked to the user's account. For example, the client based quality scheduler may be part of a streaming media player/client (e.g., a DASH client or an HLS client) which may be built into the client device and/or may be installed as an app on a client device. The client based quality scheduler may be a separate component on the client device. The client based quality scheduler may communicate with a media player/client on the client device to indicate quality levels, weights, and/or operating modes which the client device should request and/or use. The quality scheduler may reside in the network (e.g. in an operator network, or in a content provider's back end). The quality scheduler may communicate with a media player/client on the client device to indicate the quality levels, weights and/or operating modes the client device should request and/or use.

The client based quality scheduler may consider the data cost, the user's interest of the program, and the data consumption of the entire data plan cycle to determine a quality of the service to be requested. As Equation (2) shows, the service quality (Q) selection may be derived as a function of a number of parameters such as a cost (E), an amount of unused data (D), a user favorite program (P), and/or a network congestion pattern (C).

Q=ƒ(α₀*E,α₁*D,α₂*P,α₃*C) (2)

Where α is a weighting factor for each parameter (for example, α₀, α₁, α₂, α₃ . . . or collectively, αᵢ). Equation (2) may represent a weighted average of all factors or other expressions. A weighting factor's value may be either positive or negative (e.g., depending on the influence of each factor). The function ƒ( ) takes into account each of the weighted factors and determines the service quality (Q). For example, the function ƒ( ) may add all the weighted factors together. The service quality (Q) may corresponds to a quality of service to be requested. Note that as a special case of Equation (2), the weighted factors may be set to equal values (e.g., all weights may be set to 1) such that the service quality (Q) may be expressed as the more general function Q=ƒ(E, D, P, C). One or more of the weighted factors may be set to zero, resulting in other variations of Equation (2) in which quality Q may be expressed as a function of a subset (e.g., any subset) of the parameters {E, D, P, and C}.

In a video streaming use case, the service quality (Q) may be assumed to be directly related to the bandwidth of the video content that a client will request in a video streaming session. For example, the relationship between Q and the video bandwidth (BW) may be maintained in a look-up-table (LUT). For each given value of Q in a range of Qₘᵢₙ to Qₘₐₓ, the corresponding BW value may be determined based on the LUT. In another example, the relationship between Q and BW may be maintained as a function BW=g(Q), with Q in the range of Qₘᵢₙ to Qₘₐₓ, and BW in the range of BWₘᵢₙ to BWₘₐₓ. The function g(Q) may be linear or non-linear.

Equation (2) may be rewritten as Equation (3) to directly calculate the bandwidth to be requested based on the set of parameters, E, D, P and C.

BW=g(Q)=ƒ′(α₀*E,α₁*D,α₂*P,α₃*C) (3)

The BW of the video to request may be calculated by applying a scaling factor to the total available bandwidth using Equation (4):

BW=s·BWₐᵥₐᵢₗ (4)

BWₐᵥₐᵢₗ may denote the currently available bandwidth, s may be the scaling factor, 0<s≤1, and/or s may be calculated using Equation (5):

$$s = {α}_{0} * \frac{{E}_{ma x} - E}{{E}_{ma x}} + {α}_{1} * \frac{{D}_{ave \_ re m}}{{D}_{ave \_ total}} + {α}_{2} * \frac{P}{{P}_{favorite}} + {α}_{3} * \frac{{C}_{peak} - C}{{C}_{peak}} \qquad ( 5 )$$

E may denote the current cost of data. Eₘₐₓ may denote a highest cost that the user is willing to pay. Dₐᵥₑ_{_}ᵣₑₘ may be an average daily available data for the remaining days in the pay period. Dₐᵥₑ_{_}ₜₒₜₐₗ may be an average daily available data for the entire pay period. P may denote a preference score for the current video program to be requested. P_{favorite} may denote a highest preference score that the user has for a favorite program (for example, if P is rated on a scale of 1 to 5, then P_{favorite} may be equal to 5). C may denote a current network congestion factor. Cₚₑₐₖ may denote a highest network congestion factor.

The value of C may be communicated from the network operator (e.g., a base station) to a WTRU. The WTRU may calculate an estimated value of C, for example, by comparing a currently available bandwidth BWₐᵥₐᵢₗ to an average available bandwidth, or to a maximum available bandwidth. If BWₐᵥₐᵢₗ is significantly lower than the average or the maximum available bandwidth, the WTRU may determine that the current network congestion factor C is high (e.g., close to Cₚₑₐₖ). {αᵢ, i=0 . . . 3} may be the set of weights that corresponds to each of the E, D, P, C parameters. The set of weights may add up to be 1 (e.g., to normalize the range of s to be between 0 and 1). For example, α₀+α₁+α₂+α₃=1.

Using the calculation in Equation (5), one or more of the following may be observed for the value of the scaling factor s.

As E gets close to Eₘₐₓ (e.g., when the current data cost is relatively high), s may become smaller. As s becomes smaller, the currently available bandwidth BWₐᵥₐᵢₗ may be used more conservatively.

If a user has reduced the amount of daily data quota available per day for the remaining pay period (e.g., the user used most of the monthly data quota in the first half the month), s may become smaller, which may lead to a more conservative use of the currently available bandwidth BWₐᵥₐᵢₗ. The values of Dₐᵥₑ_{_}ᵣₑₘ and/or Dₐᵥₑ_{_}ₜₒₜₐₗ may be calculated using the following Equation (6) and Equation (7), respectively:

Dₐᵥₑ_{_}ᵣₑₘ=(Dₜₒₜₐₗ−D_{scheduled}−D_{used})/Nᵣₑₘ (6)

Dₐᵥₑ_{_}ₜₒₜₐₗ=Dₜₒₜₐₗ/Nₜₒₜₐₗ (7)

where Dₜₒₜₐₗ may denote a total data quota that the user has for a given pay period (e.g., for each month). D_{scheduled} may denote an amount of data which may be required (e.g., predicted as needed) to stream one or more favorite/regular programs that the user regularly watches and may have been already scheduled for the remaining days in the pay period (e.g., estimated based on the lengths of the videos and the average network speed). D_{used} may denote the amount of data that the user has already used during the same pay period. Nᵣₑₘ may denote the number of remaining days in the pay period. Nₜₒₜₐₗ may denote a total number of days in the pay period.

For an unlimited data plan where part of the data (e.g., 2 GB) is qualified for the high speed wireless network (e.g., 4G LTE) whereas any data usage exceeding a threshold may be switched to lower speed wireless network (e.g., 2G or 3G HSPA UMTS network), Dₜₒₜₐₗ value may be set to the amount data that is qualified for the highest network speed. When Dₐᵥₑ_{_}ᵣₑₘ becomes negative after the data service switches to the lower speed network, α₁ may be set to zero to disable such factor. For example, the value of α₁ may be determined (e.g., adaptively changed) based on the data usage.

The value of s may be set closer to 1 for the user's more favorite programs (e.g., programs for which the user preference parameter P has a higher value). When s is closer to 1, more of the available bandwidth BWₐᵥₐᵢₗ may be utilized.

During the network's peak hours when congestion is more likely to occur (e.g., C is closer to Cₚₑₐₖ), s may become smaller. When s is smaller, the available bandwidth BWₐᵥₐᵢₗ may be used more conservatively. A network operator may indicate to a client (e.g., user) that network congestion level is high, for example by sending a signal from a base station to a WTRU. The signal may indicate a projected congestion level. The user may determine to reduce the BW of the video content that it requests and/or may receive certain incentives from the network operator as a reward. Client/server collaboration and cooperation may reduce congestion in the entire network.

One or more of the factors (e.g., E, D, P, and/or C) in Equation (3) and (4) may be disabled by setting the corresponding α to 0. For example, if a user has an unlimited data plan with a carrier, and/or the user is using home or work place WiFi with no data quota (e.g., in the practical sense Dₜₒₜₐₗ is infinity), the user may set the corresponding weight α to 0, such that the scaling factor does not depend on the amount of data already used and/or already scheduled to be used. The weight α may be automatically set to 0, for example, in response to detecting a WiFi connection or another situation where data usage is unlimited and/or free. One or more of the weighting factors may be determined based on a user input. For example, a user interface may be provided for the user to indicate that for one or more favorite programs (e.g., for those programs for which P=P_{favorite}), the user wants to use 100% of the currently available bandwidth, without any consideration for data cost and/or congestion level (e.g., set α₀, α₁, and α₃ to 0 and set α₂ to 1). The quality control may determine s according to Equation (8):

$$s = \{ \begin{matrix}1 , & if P = {P}_{favorite} \\ \begin{matrix}{α}_{0} * \frac{{E}_{ma x} - E}{{E}_{ma x}} + {α}_{1} * \frac{{D}_{ave \_ re m}}{{D}_{ave \_ total}} + {α}_{2} * \frac{P}{{P}_{favorite}} + \\ {α}_{3} * \frac{{C}_{peak} - C}{{C}_{peak}} ,\end{matrix} & otherwise\end{matrix} \qquad ( 8 )$$

The derived Q value may be mapped to the available service qualities (e.g., those qualities provided in DASH representations). In an example of adaptive streaming using DASH like protocols, each video content may be prepared into a set of M representations with discrete set of bitrates, {BRᵢ, BRᵢ₋₁<BRᵢ, i=0 . . . M−1}. A streaming client may request a DASH representation based on a currently available bandwidth BWₐᵥₐᵢₗ. For example, the client may request the k-th representation for which BRₖ≤BWₐᵥₐᵢₗ<BRₖ₊₁. The streaming request may be based on the derived Q value, which may be associated with the value of BW calculated using Equation (4). The client may request the j-th representation bitrate for which, BRⱼ≤BW<BRⱼ₊₁. The client may determine to request an appropriate service quality (for example, a service quality that consumes less than the available bandwidth BWₐᵥₐᵢₗ).

The appropriate service quality may be requested to ensure the video data consumption stays within a budget (e.g., a quota and/or allowance) and/or to help ease network congestion. For example, when the user's data usage for that month is getting closer to the user's data plan limit (e.g., Dₐᵥₑ_{_}ᵣₑₘ is getting low), the user may calculate a small s value and/or request a lower quality representation (e.g., j<k) even though higher network bandwidth may be available to the user. When the current program is not one of the user's favorite programs, the user may request a lower quality representation (e.g., j<k), even though higher network bandwidth may be available at the moment to the user. The value of the weighting factors may be configured by the user directly or indirectly. For example, a user interface (UI) may be provided to the user. The UI may include an option to indicate whether the user considers video quality or cost more important. For a user that chooses cost over quality, higher values may be assigned to the weighting factors α₀, α₁ in Equation (2).

The WTRU battery status (B) may impact the service quality selection. For example, a first client with less battery power may determine to request a lower quality service. A second client with high battery power may determine to request a high quality service. The battery status (B) may be used in combination with the other weighting factors described herein, for example, by modifying Equation (5) as follows to Equation (9):

$$s = {α}_{0} * \frac{{E}_{ma x} - E}{{E}_{ma x}} + {α}_{1} * \frac{{D}_{{ave}_{re m}}}{{D}_{{ave }_{total}}} + {α}_{2} * \frac{P}{{P}_{favorite}} + {α}_{3} * \frac{{C}_{peak} - C}{{C}_{peak}} + {α}_{4} * \frac{B}{{B}_{ma x}} \qquad ( 9 )$$

Where the variable B may denote the current battery level, Bₘₐₓ may denote the maximum battery level at full charge, and α₄ may denote the weight corresponding to the battery factor. To ensure the value of s is normalized, α₀+α₁+α₂+α₃+α₄=1.

Even though the bandwidth may be sufficient and the higher quality program may be available, the scheduler may request a low quality service, low-bandwidth media, and/or local stored alternative media when the data cost exceeds a user's budget. The scheduler may request a low quality service, low-bandwidth media, and/or local stored alternative media when the user is not interested in the media information (e.g., the user would like to listen to the music but does not want to watch the music video when watching online video such as YouTube). The scheduler may request a low quality service, low-bandwidth media, and/or local stored alternative media when the scheduler has to allocate an amount of data to be consumed for upcoming events (e.g., such as regular news report, or an upcoming special sport event or TV show). The user may be able to control the media service spending under the budget. The user may receive one or more favorite programs in high quality service.

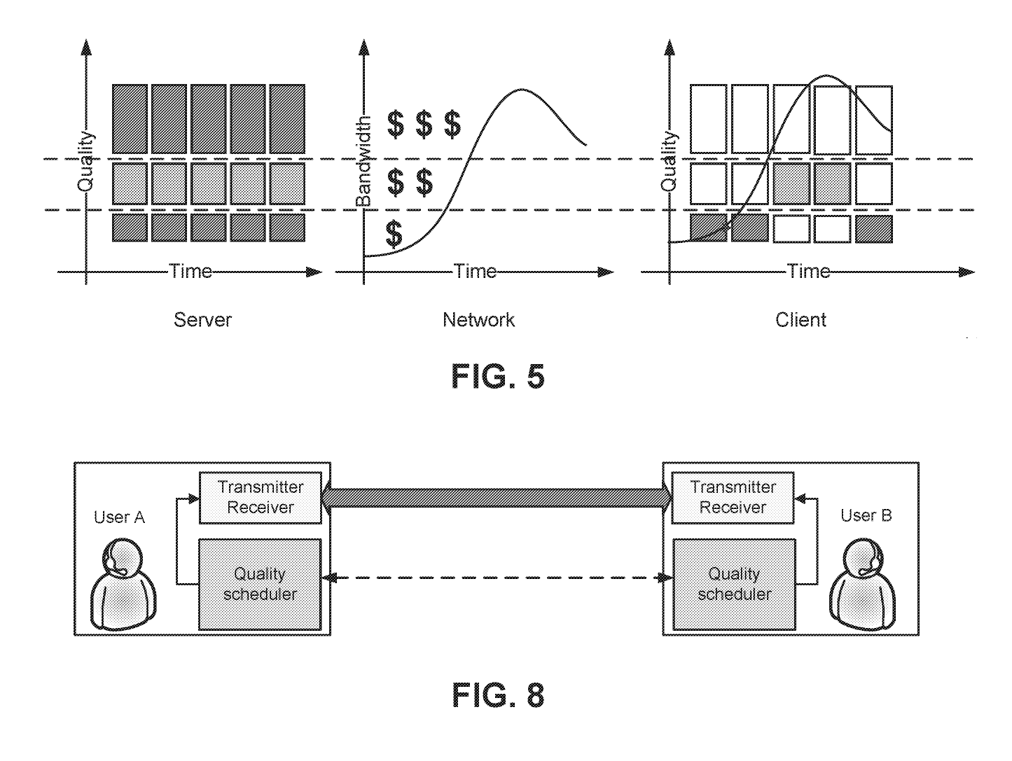

FIG. 5 depicts an example client centric service quality control based adaptive streaming. A client may manage the data consumption. For example, the client may request a medium quality representation at medium cost ($$) instead of a high quality video at high cost ($$$) even when the bandwidth is sufficient for requesting high quality representation (e.g., to reduce data consumption and/or offload the network traffic in a cost-effective manner).

A quality scheduler may be pre-programmed into a number of modes. Each of the number of modes may include assigning appropriate weights in Equations (5) and (9). The number of modes may include a quality mode, a cost mode, and/or a balanced mode. When the quality scheduler is programmed into the quality mode, data may be requested at a highest quality service regardless of the cost. When the quality scheduler is programmed into the cost mode, data may be requested at a somewhat reduced quality level when cost is high in order to keep the data consumption cost within a predetermined budget. When the quality scheduler is programmed into the balanced mode, data may be requested at a quality level based on a balance (e.g., an even balance) among factors such as data cost, battery usage, network congestion level, and/or program quality.

When quality mode is selected, a user may consider highest quality to be the most important factor. For example, the user may attempt to use all of the currently available bandwidth. A weighting factor for preferences may be set at a high value in quality mode. The service quality (Q) parameter may be ignored by an application running in quality mode. The value of s in Equation (4) may be set to 1.

When cost mode is selected, a user may be more focused on lowering the data cost than obtaining the highest quality of service. In cost mode, the weighting factor α₀ may be set to a high value (e.g., set to 1 or very close to 1) such that cost (E) has a higher impact in determining the scaling factor s and/or the quality of service selection (Q).

When balanced mode is selected, a user may consider various factors, including data usage, battery usage, and/or network congestion level, while maintaining good user experience. In balanced mode, similar weights (e.g., equal weights) may be assigned to the weighting factors such that service quality (Q) is selected taking into account E, D, P, C, and B in a balanced manner.

An application may switch among modes based on various factors. For example, if the user is in a regular service area and has unlimited data coverage, the quality mode may be enabled to maximize video quality. When the user is roaming with limited data availability and at high roaming cost, the user may switch from the quality mode to the cost mode. The user may determine to stay in the balanced mode instead of switching modes. Switching modes may be done manually (e.g., using a UI setting provided to the user) or automatically (e.g., enable cost mode automatically when roaming). The same mode may be used for all applications that include high data usage (e.g., for Netflix, YouTube, and/or FaceTime). Different modes may be used for different applications (e.g., FaceTime may use quality mode, Netflix streaming may use balanced mode, and/or YouTube may use cost mode). A user interface may allow the user to set a preferred operating mode for one or more individual applications and/or for one or more groups of applications (e.g., application types).

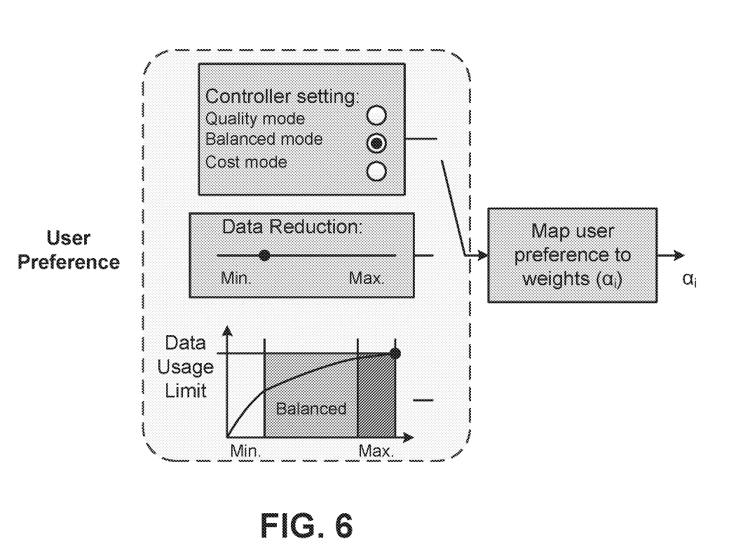

FIG. 6 depicts an example of various options for user preference selection of data reduction setting. A user may define the value of the weighting factors manually. The user may determine the value of the weighting factors via various user interface setting options. The user may select one or more default quality modes and/or may select a desired amount of data reduction. One or more preferences may be mapped to one or more weighting factors, based on the one or more default quality modes and/or the desired amount of data reduction, prior to being used in determining the service quality (Q). The weighting factors may be adjusted dynamically, for example, based on a data usage limitation. A user may select a desired amount of data reduction and/or a desired quality controller mode setting (e.g., quality mode, balanced mode, or cost mode). For example, the user may indicate a desired 50% data usage reduction. The desired data usage reduction may be translated to an upper bound for scaling factor s. For example, after calculating s based on Equation (5) and/or (9), s may be determined to be s=min(s, 0.5). Setting an upper bound for scaling factor s may ensure that the data usage is limited to be within a predetermined threshold.

A popular data plan from the carriers may be the shared family data plan. With a shared family data plan, family members may share a total amount of data quota. The quality controller, described herein, may be used individually for each of the family members. A group quality controller may be used to control the bandwidth and/or data usage for each of the family members together. For example, when one or more family members (e.g., the teenagers in the family) have used much of the data quota, other family members (e.g., the parents) may limit the amount of data they consume, such that the total data quota on the family plan is not exceeded.

The data cost D in the group quality controller may take into account data usage of all group (e.g., family) members. For example, the definition of variables in Equation (6) may be modified as follows. Dₜₒₜₐₗ may denote the total data quota that all of the users in the group have for a given pay period (e.g., for each month). D_{scheduled} may denote the one or more favorite and/or regular programs that all users in the group regularly watch that have been scheduled for the remaining days in the pay period. D_{scheduled} may be estimated based on the lengths of the videos and/or the average network speed. D_{used} may denote the amount of data that all users in the group have already used during the same pay period.

The group quality control may provide parental control capabilities that may be applied to other members of the group. The parental control capabilities may balance the usage from different users and/or ensure that data quota is not exceeded. One or more master users (e.g., parents) may set individual data usage limits for each of the subsidiary users. For example, the overall data quota may be divided among the each of the subsidiary and master users and the individual data usage limits for each user may be used in the calculation of Equation (6). The one or more master users may determine a data reduction target (e.g., as shown in FIG. 6) for one or more subsidiary users. For example, a hard limit on the value of s (e.g., the percentage of currently available bandwidth) may be enforced for the one or more subsidiary users. The data reduction target may be set to 0 temporarily, for example when the master user wants to take away the data usage privilege temporarily for some subsidiary users. The one or more master users may have the authority to change the mode setting of the quality controller for the subsidiary users. The authority to change the mode setting may include overriding one or more subsidiary users' quality mode setting (e.g., from quality mode to cost mode). A centralized quality controller may be implemented directly on the one or more master users' WTRUs. The centralized quality controller may enable the one or more master users to control the settings of each user in the group directly from the one or more master user's WTRUs (e.g., instead of manually adjusting the quality controller setting on each WTRU in the group). The centralized quality controller may be implemented in the cloud, and only the one or more master users may be granted access to the centralized quality controller.

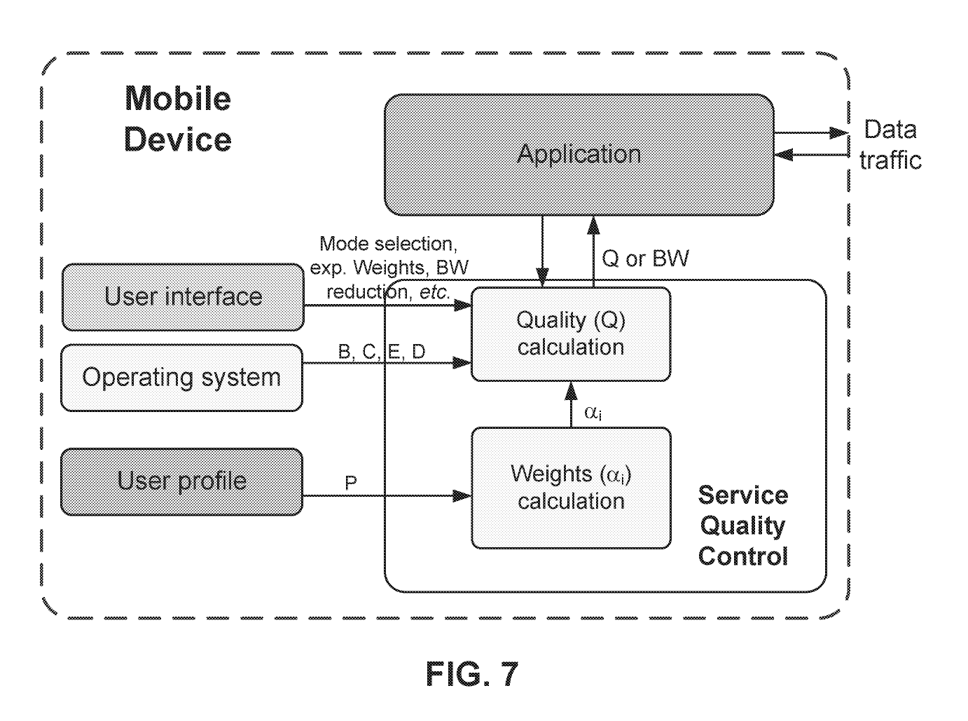

FIG. 7 depicts an example service quality controller. The service quality controller may receive information from various sources, including one or more of: user preferences for each factor (e.g., provided through user interface), the WTRU operating system information, and/or user profile information. The user preferences may include explicit weight factor settings and/or selection of a controller mode. The WTRU operating system may include data allowance, usage statistics, congestion level, and/or battery usage statistics. The user profile information may include data usage habits and/or program preference. Based on the received information, a service quality (Q) may be calculated according to Equations (5) and/or (9). The calculated service quality (Q) may be available to one or more associated applications through request (e.g., via an API) and/or when a change occurs (e.g., via a callback). The one or more associated applications may adjust the bandwidth consumption according to the value of Q provided by the service quality control.

The service quality controller may be associated with video streaming applications, other applications, and/or used in other use cases. For example, the derived Q from Equation (2) may be used to select an uplink service quality (e.g., uplink bandwidth) when uploading the user-generated content to the server. The uplink bandwidth may be more regulated than downlink bandwidth. For example, uploading video content may count toward user data plan usage and may consume more battery power to transmit than downloading video content. The user may convert a captured video to a lower quality format before uploading. For example, when the user's data plan is running low, and/or when device battery is running low, the user may consider converting the captured 4K video into HD or SD format, and uploading the HD or SD format video.

The quality scheduler and/or the derived Q value may be applied on other services and/or applications.

For internet browsing applications, a web browser (e.g., such as Chrome or Firefox) may use the service quality (Q) to determine how much information may be downloaded and/or presented to the user during a session. For example, the web browser may be set to “text only” web page modes when the user has selected the “cost mode.” In “text only” web page mode, the user may only receive text-based web pages (e.g., without the embedded videos and/or images). If the user has selected balanced mode, some low-resolution previews of images and/or video may be downloaded. The web browser may include an option for the user to download a full version of the web pages when desired (e.g., such as a “click to show” option).

For location navigation applications, the quality scheduler may derive the value of Q from Equation (2) and may determine the level of details at which the map content will be downloaded. For example, if the user is in the cost mode, full resolution map information may be downloaded within a small radius of a current location. For surrounding areas beyond a few blocks from the current location, map information may be downloaded at a lower resolution. If the user is in balanced mode, high resolution map information and/or information about one or more businesses in the area may be downloaded. If the user is in quality mode, detailed map information, satellite views, street views, and/or video based local business information may be downloaded. For navigation applications, in order to decide the value of Q, besides the equations described herein, the service quality controller may consider how fast the user is moving. For example, while the user is moving at a fast speed (e.g., driving a car on a highway), only low resolution map information may be needed and other information such as landmarks along the way, local businesses, satellite maps, etc, may not be downloaded (e.g., since it is unlikely that the user will need such information). The service quality controller may modify Equations (7) and/or (9) to further take into account the current speed S of the user. For example, the value of the calculated scaling factor s may be reduced when the current speed S is higher than a predetermined threshold.

FIG. 8 depicts an example quality scheduler for real-time video communications. For real-time device-to-device (D2D) communications such as video chat, the quality scheduler may reside on both devices (e.g., a first WTRU and a second WTRU). The devices may negotiate with each other to manage the data transmission rate of both clients. For example, a user of the first WTRU may select only low-bandwidth media to be displayed on the first WTRU and/or block display of higher-bandwidth media even though it may have been sent by the second WTRU. The first WTRU may replace received media information with alternative media information stored in a terminal memory (e.g., in order to reduce communication resources). Sending high resolution, high quality video over the network with high uplink bandwidth cost may be inefficient based on the receiving WTRU's quality mode. The quality scheduler of the receiving WTRU may communicate with the quality scheduler of the transmitting WTRU to reduce the transmission rate. For example, the transmitting WTRU may reduce the video resolution, reduce the frame rate, and/or encode the video at a specific bitrate configured by the receiving WTRU. When the user of the receiving WTRU is displaying the pre-stored media information, the receiving WTRU quality scheduler may request the transmitting terminal quality scheduler to stop sending any video to the receiving terminal so that both uplink and downlink data consumption may be saved.

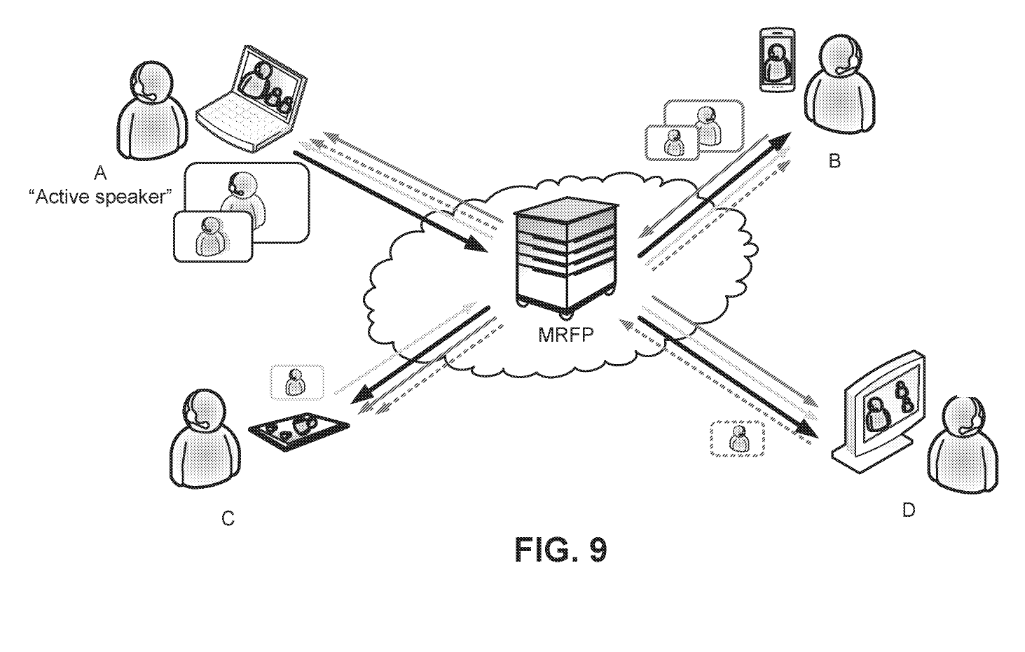

FIG. 9 depicts an example multi-party video conference. For applications such as multi-party video conferencing, each participant's WTRU may be connected to the Multimedia Resource Function Processor (MRFP). The MRFP may make connections among multiple video conferencing endpoints, may receive video streams from each endpoint, and/or may forward a set of appropriate video streams to each endpoint.

The quality scheduler of each end user device may request a desired uplink and/or downlink service quality to the MRFP. Users who would like to share a good quality video with other participants may choose high quality mode. The MRFP may manage the video with different qualities (e.g., via transcoding or using scalable video bitstreams) to send the video to other users in the group. A user may be able to receive another participant's video from the MRFP based on the user's quality controller setting and/or mode selection. For example, the user may receive a high quality content from the active speaker and medium/low quality content from the other participants. The quality scheduler of the user may switch to the cost mode when the user is running out of data plan, running low on battery, and/or not interested in the active speaker at the time. Based on the quality request from each participant, the MRFP may notify the participant to encode and/or transmit the video content with the desired bandwidth.

Besides a DASH server with pre-loaded data representations at different quality and data rate, the network operator may route the mobile data traffic through data traffic compression and/or transcoding servers on the fly (e.g., such that data rate may be reduced by the servers before presenting it to the end users). For example, when users request particular content, the request and/or the response may be sent through an optimization and compression server. The data (e.g., mainly text, images and media) may be compressed and sent to the end users at a low bitrate. The mobile client WTRUs may decompress the data before presenting it to the end users. Data traffic of the users in the cost mode and/or with the lower Q values derived from Equation (2) may be routed through the data compression and/or transcoding servers (e.g., to deliver the content at a reduced data rate to the client). Users in the quality mode and/or users with higher Q values may be sent the original images and/or media.

The quality controller may be associated with a wide variety of applications. The quality controller may be used to control the quality (e.g., bandwidth usage) of the wide variety of applications. The wide variety of application may include video streaming, video chat, web browsing, location navigation, and/or multi-party video conferencing. The user may be able to set the quality controller to different settings for different applications. For example, the user may select the quality mode for video streaming applications and select the cost mode for web browsing applications. The user may have a bias toward using the bandwidth more aggressively (e.g., with the value of s closer to 1) for video streaming and less aggressively (e.g., with the value of s closer to 0) for web browsing. In another example, the user may not enforce a bandwidth reduction target (e.g., set a first data reduction target to 1) for video chat applications such as FaceTime and may enforce a 50% bandwidth reduction target (e.g., set a second data reduction target to 0.5) for location based navigation services.

The service quality control may be related to the network. Due to the net neutrality policy, network operators may not be able to charge differently depending on the type and/or origin of the content, network traffic or the users. It may not be cost-effective for the network operators to continue expanding the infrastructure to fulfill the bandwidth demands during the peak time. To re-allocate extra bandwidth to the premium clients without throttling the network speed periodically, the network operators may communicate with the quality scheduler so that the regular users may reduce data consumption and/or service quality in exchange for certain incentives provided by the network operators.

For example, the network operators may negotiate with the quality scheduler on the user WTRUs to offer one or more incentives to reduce data usage during peak hours. For example, users may get lower rates and/or bonus data credits from the network operators for reducing data usage during peak hours. For users to take advantage of incentives, the user may allow the network operator to influence the quality scheduler settings. For example the user may apply a non-zero weight to the parameter C in Equations (5) and (9). The quality scheduler may be configured to switch modes based on the time of the day.

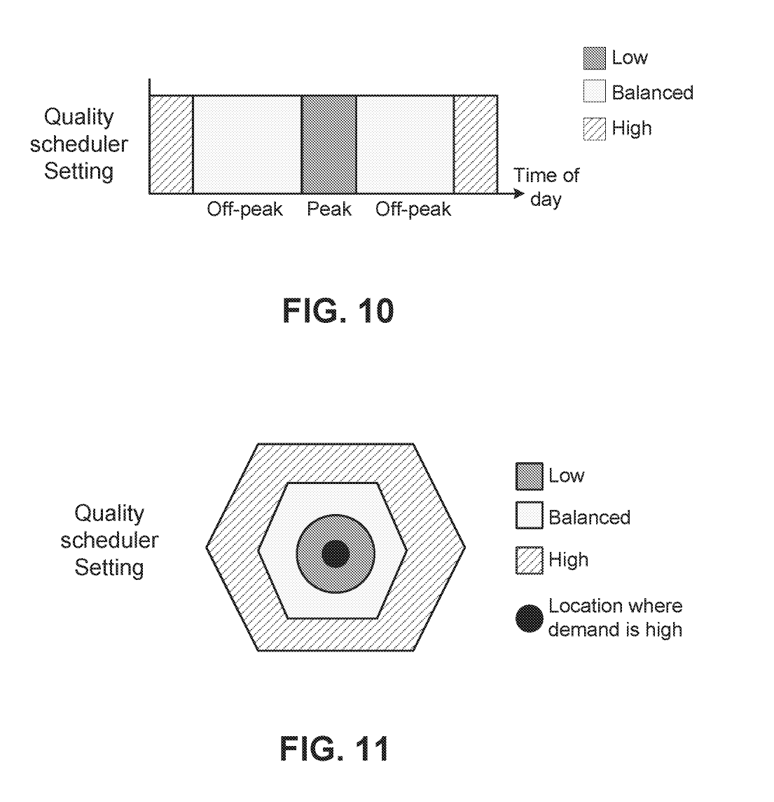

FIG. 10 depicts an example quality of service setting during peak and off-peak hours. For example, the quality controller on the user WTRUs that allow the network operator to influence the quality scheduler settings (e.g., the compliant WTRUs) may be automatically set to the cost mode during peak hours, balanced mode during off-peak hours, and/or quality mode when data capacity is not a concern for the network operators.

FIG. 11 depicts an example quality of service setting based on location. Network operators may offer one or more incentives to reduce data usage when the compliant users attend events where capacity on the data network is expected to be high (e.g., at malls, an important sports event, or other large public events). Data reduction settings may be dynamically changed based on the location of the compliant user. For example, cost mode may be set when users are in areas where demand is high, balanced mode may be used when customers are in less crowded areas, and/or quality cost may be used in areas where data capacity is plenty. Location of customers may be obtained using APIs.

A content aggregator and/or an advertisement provider may negotiate with the quality scheduler (e.g., to encourage the user to watch specific programs or advertisement at relatively high quality levels). For example, the advertising provider may reward more credits back to the users who watch a high quality advertisement than those who watch a low quality advertisement. Using the quality controller described herein, the mode setting of the quality controller of one or more compliant users may be temporarily increased when advertisements from sponsoring providers are being received. For example, the content aggregator may interact with the quality scheduler on compliant users to increase the value of s, thereby increasing the video quality for the client when a sponsored advertisement is being displayed.

The quality scheduler may enable a client to dynamically switch among various available network carriers based on the data cost and/or service quality (e.g., especially for the expensive data plan such as international roaming). Each network carrier may offer data and cost packages to the client who is requesting a service. The client may select a network carrier among multiple carriers. The quality scheduler on the client WTRU may estimate an approximate amount of data that the user may need to consume based on the user's personal profile. The quality scheduler may indicate, to the multiple carriers, the approximate amount of data to be consumed, the particular time those data would be consumed, the data roaming location, the expected quality of the service, and/or the desired cost range. Based on this set of information, each network carrier may make an offer to the client based on the carrier's network traffic conditions, resource availability, and/or the profit margin. The client may benefit from having multiple network carrier candidates to select from. The network carriers may benefit from being able to fully utilize its available bandwidth resource.

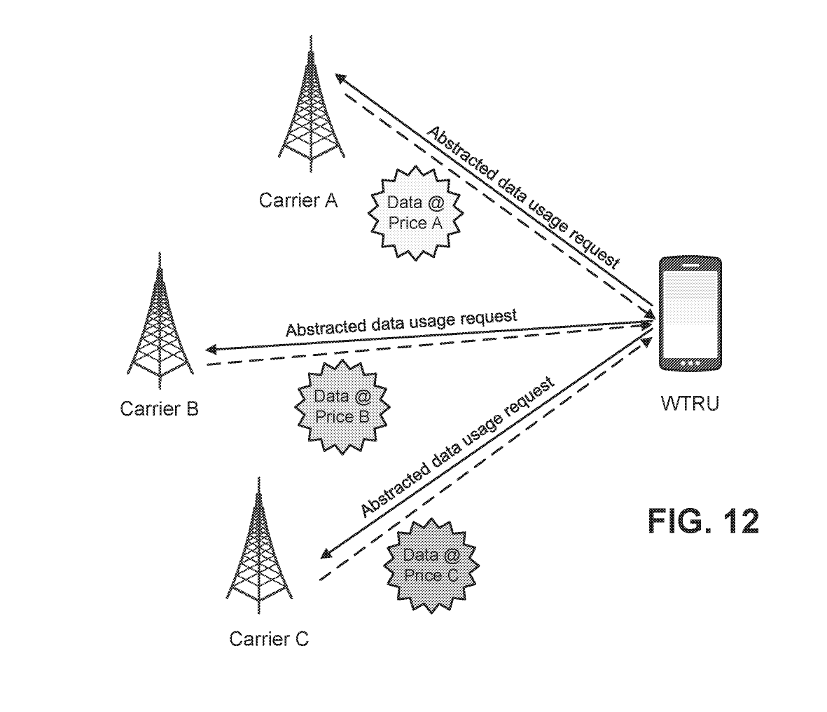

FIG. 12 depicts an example network carrier data package selection. For example, the client may send data requests by sending the abstracted data usage information (e.g., amount of data usage needed, time/day of usage, location information, costs, etc.) to each network carrier (e.g., A, B and C). Each carrier may make a data package offer (e.g., on the fly). The client may select a carrier based on a desired tradeoff between price and service quality.

The quality of service selection may be extended beyond the scope of network bandwidth and/or data bitrate.

A quality of service (QoS) metric may be used to indicate the quality of service to customers. QoS metrics with regard to network service may include one or more of availability, delivery, latency, bandwidth, mean time between failures (MTBF), and/or mean time to restore service (MTRS). Availability may represent a percentage of available services among overall service requests. Delivery may represent a percentage of services being delivered without packet loss or packet delay. Latency may represent the time taken for a packet to travel from a service access point (SAP) to a distant target and back (e.g., including the transport time and queuing delay). Bandwidth may represent the available capacity. MTBF may represent the predicted elapsed time between inherent failures of a service during operation. MTRS may represent the average time to restore service after a service failure is reported.

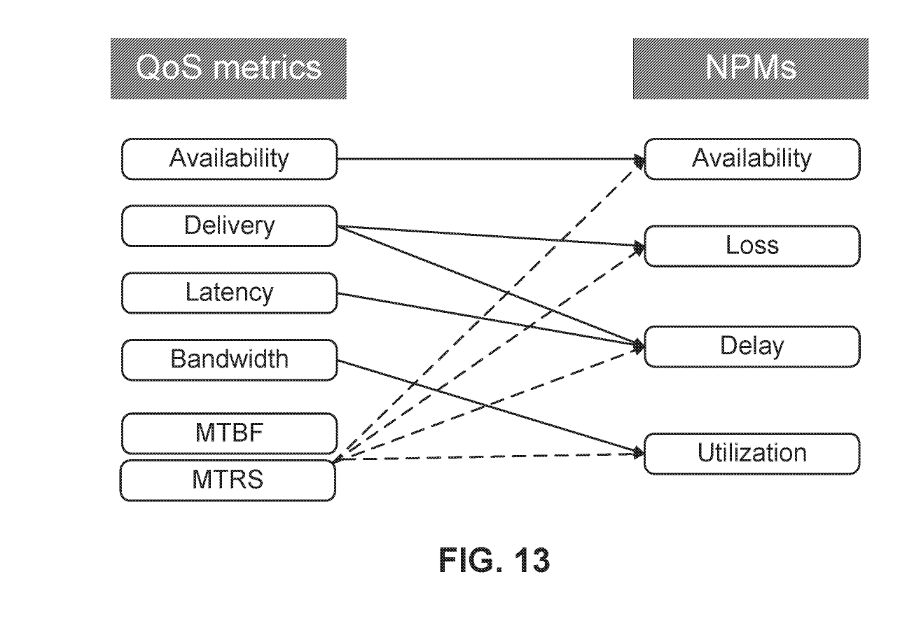

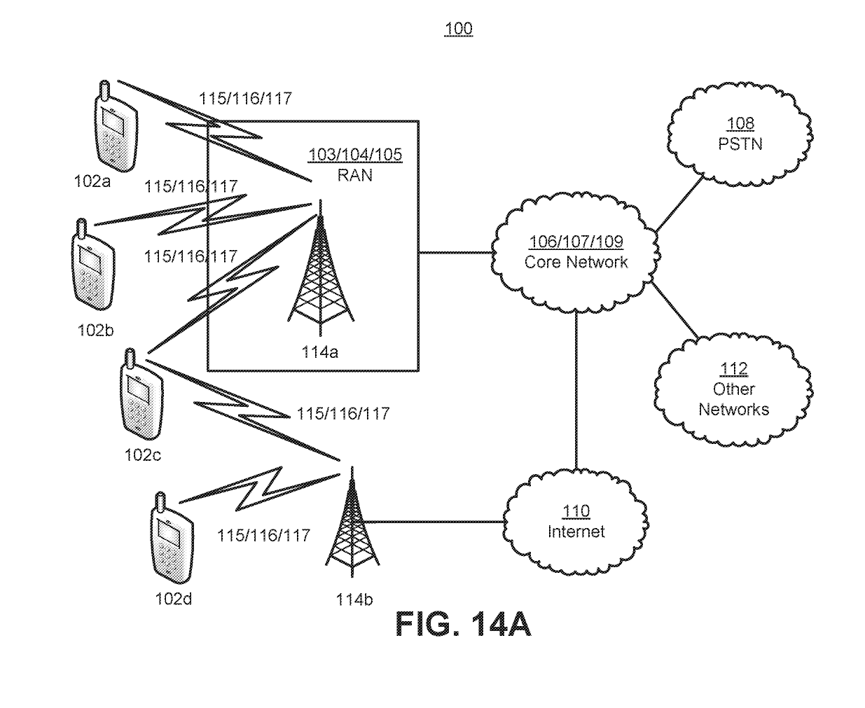

A network performance metric (NPM) may be the basic metric of performance measurement in the network management layer. FIG. 13 depicts an example mapping of QoS metrics to NPMs. NPMs may be categorized into one or more of availability, loss, delay, and/or utilization categories. The availability category may represent connectivity and/or functionality in the network management layer. Connectivity may be the physical connectivity of one or more network elements. Functionality may indicate whether the associated network devices are functioning properly. The loss category may represent a fraction of packets lost in transit from a sender to a target during a specific time interval (e.g., usually expressed in percentages). The delay category may represent the time taken for a packet to make an average round or one-way trip between the sender and a distant target. The utilization category may represent the throughput for the link expressed as a percentage of the access rate.

The contract between service providers and customers may be performed using QoS parameters and/or the network quality as measured using NPMs. A QoS parameter may be mapped to one or more NPMs. The mapping of the QoS parameter to one or more NPMs may depend on a type of service.

Based on one or more user preferences of particular parameters of the QoS metrics such as availability, delivery, latency, and/or bandwidth, the quality scheduler may be mapped to the corresponding NPM. A specific quality of service provided by the operators may be requested. For example, a user gambling on a real-time sport game may prefer very low latency broadcast/multicast services, but may not care about the video quality. A user watching a favorite movie may prefer high quality but may not care about the latency. The operators may provide various tiers of data channel options to users. The various tiers of data channel options may match the quality of service metrics. The users may subscribe to different data options based on the decision of the quality scheduler.

Augmented Reality (AR) may include presenting an enhanced version of reality by overlaying digital information and/or computer generated graphical objects on an image being viewed through a WTRU (e.g., a smartphone's camera or a headset). The computer generated graphical objects may be represented as 3D mesh models defining the surface of the object and/or texture images that cover the surface. The 3D mesh models for the different objects and/or their associated textures may be stored on a server and may be streamed to the WTRU where a graphic processing unit renders these objects on the displayed image. Both the 3D meshes and textures may be compressed at different levels to reduce the amount of data that needs to be transmitted at the cost of reducing the quality of the rendered objects. Several factors may affect the service quality requested by the user when streaming AR content. The factors may include those described herein including, the cost on the user, the amount of remaining unused data, user preference, traffic congestion levels, and/or battery power.

A client may dynamically calculate a service quality value (Q) using one or more of the factors described herein as input. The client may provide the calculated service quality value (Q) to the server over a feedback channel. A scheduler running on the server-side may utilize the calculated service quality (Q) to determine a suitable version of the content to be streamed to the client. The quality of one or more objects presented to the user may be determined based on data reduction settings. For example, the server may stream only the most important objects to the client when the cost mode is selected. The server may send low resolution textures and/or highly compressed meshes for all objects when the cost mode is selected. If the balanced mode is selected, a summary of the models may be transmitted at a high quality (e.g., with low compression) while reducing the quality of the textures. If the quality mode is selected, data reduction may be disabled and/or both the meshes and the textures may be transmitted at a highest quality.

A quality representation of a video may be requested based on a bandwidth condition. A scheduler may be pre-programmed with a number of quality modes. A quality control may be used to control the bandwidth and/or data usage of each user in a group data plan. One or more network operators may negotiate with a quality scheduler on one or more user WTRUs to offer incentives for data usage reduction. Quality control may be implemented for augmented reality content.

A quality of service to be requested in a video streaming session may be determined. The determined quality of service may be mapped to an available service quality. A video representation associated with the available service quality may be requested. One or more favorite programs may be indicated via a user interface. A quality-cost preference may be indicated via the user interface. The quality of service may be determined based on one or more of a cost, an amount of unused data, one or more favorite programs, a battery status, or a network congestion pattern. A low quality video representation may be requested based on a user data allowance threshold.

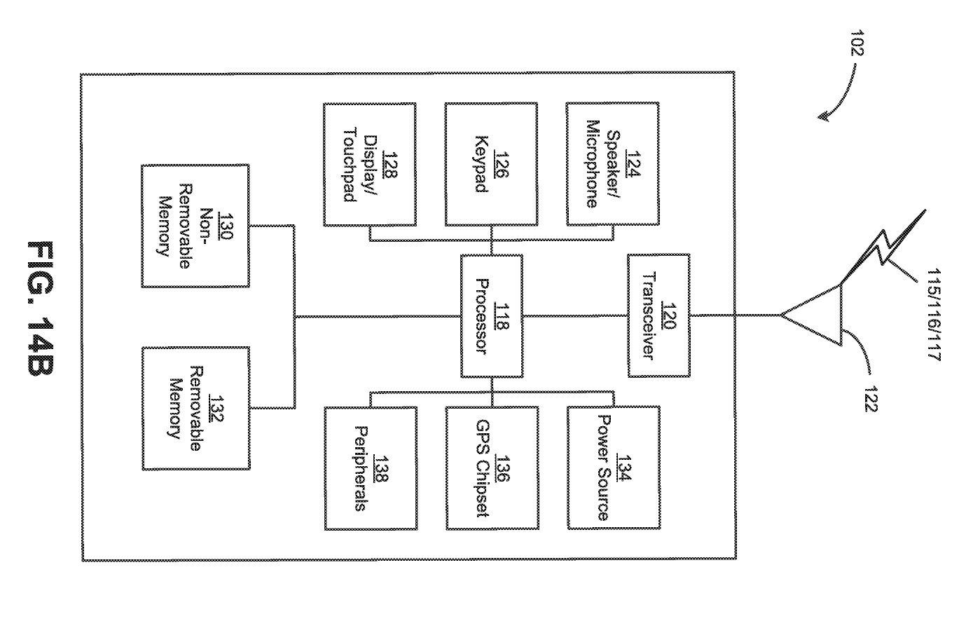

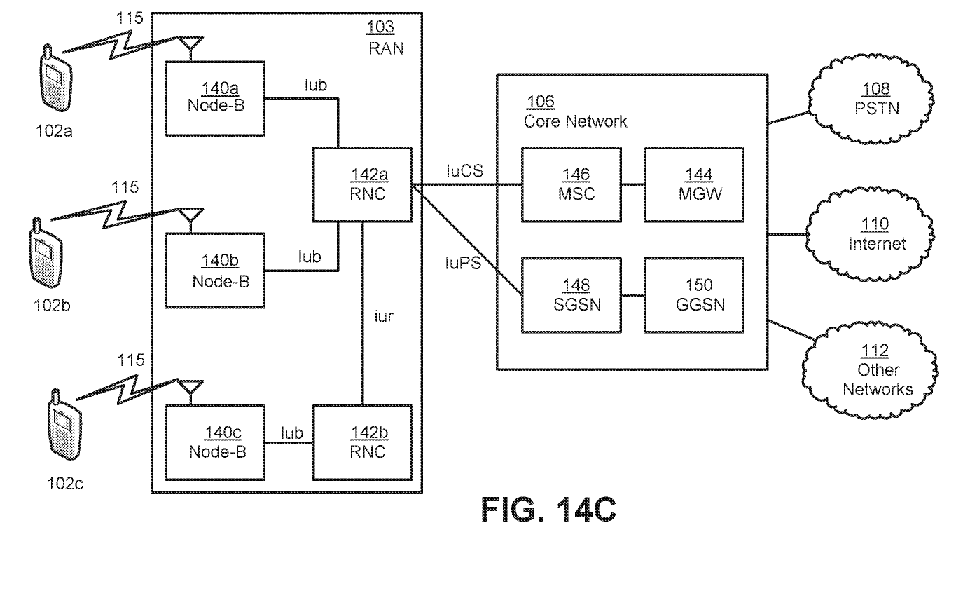

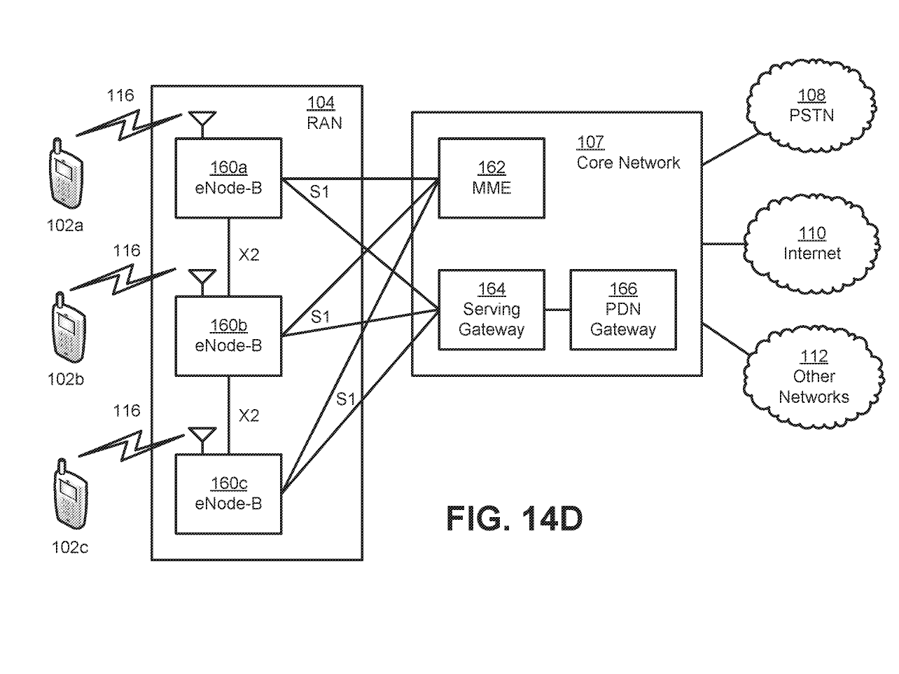

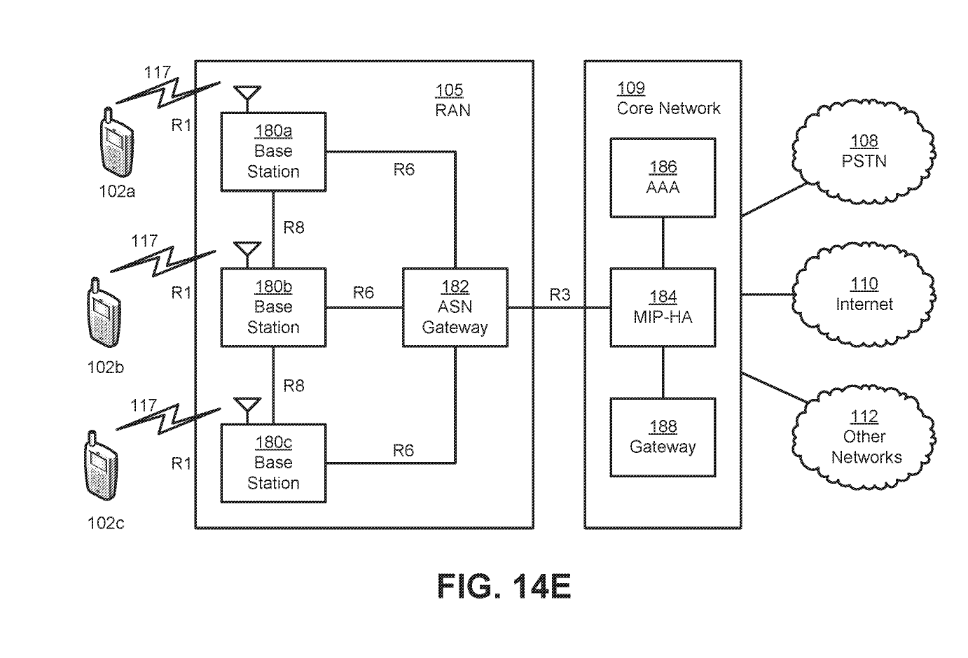

FIG. 14A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 14A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, e.g., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, 102c may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 14A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 14A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 14A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities, e.g., the WTRUs 102a, 102b, 102c, 102d may include multiple transceivers for communicating with different wireless networks over different wireless links. For example, the WTRU 102c shown in FIG. 14A may be configured to communicate with the base station 114a, which may employ a cellular-based radio technology, and with the base station 114b, which may employ an IEEE 802 radio technology.

FIG. 14B is a system diagram of an example WTRU 102. As shown in FIG. 14B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 14B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 14B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 14B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 14C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 14C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 14C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 14C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 14D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 14D, the eNode-Bs 160a, 160b, 160c may communicate with one another over an X2 interface.

The core network 107 shown in FIG. 14D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 14E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 14E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 14E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 14E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer.

1. A method of managing a service quality for data consumption with a wireless transmit/receive unit (WTRU), comprising:
determining a cost associated with obtaining the data;
determining an amount of unused data in a monthly data plan;
determining a user's preference for a content type related to the data;
determining an amount of congestion in a network over which the data will be received;
determining a desired service quality value based upon the cost, unused data, preference, and network congestion;
comparing the desired service quality value to a set of representations of the data, wherein each of the representations is associated with a different service quality; and
requesting the data at a representation having a quality closest to the desired service quality value.

2. The method of claim 1, further comprising weighting one or more of the cost, unused data, a user's content preference, and network congestion to affect its influence upon the service quality value determination.

3.-5. (canceled)

6. The method of claim 2, wherein a weighting factor for the user's content preference is set to a higher value, wherein the user's content preference is determined based upon one or more of a specific content, a content type, a manual input via a user interface, or an inference from user viewing habits.

7.-8. (canceled)

9. The method of claim 2, wherein a weighting factor for network congestion is set to a higher value, further comprising requesting the data at a representation having a service quality lower than the desired service quality in exchange for an incentive.

10. (canceled)

11. The method of claim 2, wherein a weighting factor for unused data is set to a higher value, further comprising setting a data reduction target for one or more subsidiary users.

12.-13. (canceled)

14. The method of claim 1, further comprising determining a battery status and determining the service quality value based upon the cost, unused data, preference, network congestion, and the battery status.

15. The method of claim 1, wherein each of the representations has an associated bitrate, and wherein each bitrate is associated with a different service quality, further comprising applying a scaling factor based on the service quality value to the total available bandwidth to determine the representation having the bitrate closest to or the service quality closest to the desired service quality.

16. (canceled)

17. The method of claim 1, further comprising selecting, by a user, one of a cost mode, a quality mode, and a balanced mode, wherein the data consumption is a video streaming session, and wherein each mode is associated with a different video quality.

18. (canceled)

19. The method of claim 2, wherein the user manually selects a mode that alters one or more of the weighting factors.

20. The method of claim 1, wherein the user manually selects a media content that will be delivered at the highest available bandwidth.

21.-22. (canceled)

23. A wireless transmit/receive unit (WTRU), comprising:
a processor for managing a service quality for data consumption, the processor configured to:
determine a cost associated with obtaining the data;
determine an amount of unused data in a monthly data plan;
determine a user's preference for a content type related to the data;
determine an amount of congestion in a network over which the data will be received;
determine a desired service quality value based upon the cost, unused data, preference, and network congestion;
compare the desired service quality value to a set of representations of the data, wherein each of the representations is associated with a different service quality; and
request the data at a representation having a bitrate closest to the desired service quality value.

24. The WTRU of claim 23, wherein each of the representations has an associated bitrate, and wherein each bitrate is associated with a different service quality.

25. The WTRU of claim 24, wherein the processor is further configured to apply a scaling factor based on the service quality value to the total available bandwidth to determine the representation having the bitrate service quality closest to the desired service quality.

26. The WTRU of claim 23, wherein the processor is further configured to weigh one or more of the cost, unused data, preference, and network congestion to affect its influence upon the service quality value determination.

27.-31. (canceled)

32. The WTRU of claim 23, wherein the user's content preference is determined based upon one or more of a specific content, a content type, a manual input via a user interface, or an inference from user viewing habits.

33. The WTRU of claim 26, wherein a weighting factor for network congestion is set to a higher value, and wherein the processor is further configured to request the data at a representation having a service quality lower than the desired service quality in exchange for an incentive.

34. (canceled)

35. The WTRU of claim 26, wherein a weighting factor for unused data is set to a higher value, and wherein the processor is further configured to set a data reduction target for one or more subsidiary users.

36.-37. (canceled)

38. The WTRU of claim 23, wherein the processor is further configured to determine a battery status and determine the service quality value based upon the cost, unused data, preference, network congestion, and the battery status.

39.-43. (canceled)

44. The WTRU of claim 23, wherein the processor is further configured to allow the user to manually select a media content that will be delivered at the highest available bandwidth.

45. The WTRU of claim 23, wherein the processor is further configured to display a user interface to allow the user to select one of a cost mode, a quality mode, or a balanced mode.
